(19) United States
(12) Patent Application Publication
(10) Pub. No.: US 2023/0309092 A1
(43) Pub. Date: Sep. 28, 2023

(54) Method And Apparatus For Lean Protocol Stack In Mobile Communications

(71) Applicant: MediaTek Singapore Pte. Ltd., Singapore (SG)

(72) Inventor: Pradeep Jose, Cambridge (GB)

(21) Appl. No.: 18/115,893

(22) Filed: Mar. 1, 2023

Related U.S. Application Data
(60) Provisional application No. 63/324,189, filed on Mar. 28, 2022.

(51) Int. Cl. H04W 72/1268; H04L 5/00; H04W 72/566

(52) U.S. Cl. CPC H04W 72/1268; H04L 5/0053; H04W 72/569; H04W 80/06

(57) ABSTRACT

Various techniques pertaining to utilization of a lean protocol stack with respect to user equipment and network apparatus in mobile communications are described. An apparatus communicates with a network node of a wireless network by utilizing a lean protocol stack. In utilizing the lean protocol stack, the apparatus performs one or more of the following: (i) a split-stack operation; (ii) data concatenation; and (iii) uplink (UL) scheduling optimization.

### CROSS REFERENCE TO RELATED PATENT APPLICATION(S)

The present disclosure is part of a non-provisional application claiming the priority benefit of U.S. Patent Application No. 63/324,189, filed on 28 Mar. 2022, the content of which being incorporated by reference in its entirety.

### TECHNICAL FIELD

The present disclosure is generally related to mobile communications and, more particularly, to techniques in utilizing a lean protocol stack with respect to user equipment and network apparatus in mobile communications.

### BACKGROUND

Unless otherwise indicated herein, approaches described in this section are not prior art to the claims listed below and are not admitted as prior art by inclusion in this section.

In mobile communications such as New Radio (NR) in accordance with the 3^{rd} Generation Partnership Project (3GPP) specification(s), uplink (UL) communication and downlink (DL) communication within a user equipment (UE) are processed through an UL user plane (UP) stack and a DL UP stack, respectively. Each NR UP stack typically involves a number of protocols and layers including: a Service Data Adaptation Protocol (SDAP) layer, a Packet Data Convergence Protocol (PDCP) layer, a Radio Link Control (RLC) layer and a Medium Access Control (MAC) layer. That is, a given NR data flow, whether UL or DL, is typically processed by the various protocols and layers through the NR UP stack. Functionality of the SDAP layer pertains to quality of service (QoS) flow(s) to radio bearer mapping and includes reflective QoS flow mapping. Functionality of the PDCP layer pertains to ciphering and integrity, header compression, split bearer operation, reordering, data duplication, and data discarding. Functionality of the RLC layer pertains to segmentation, automatic repeat request (ARQ)-based data recovery, reordering, and data discarding. Functionality of the MAC layer pertains to transport block (TB) creation and logical channel prioritization (LCP), hybrid ARQ (HARQ), scheduling information reporting, priority handling, and real-time control (e.g., via MAC control elements (CEs)).

As each packet of data is processed through a single stack, the packet is handled independently at each layer with its own header as it is processed from one layer to another through the stack. That is, the processing through the stack is on a per-packet basis. However, with higher-throughput data expected in next-generation mobile communications (e.g., holographic communication which may require high throughput but not necessarily all the NR functionality), overhead in processing data through the stack may be excessive and may negatively impact overall system performance as well as user experience. Therefore, there is a need to address such issues with a solution of a lean protocol stack in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions and/or schemes pertaining to techniques in utilization of a lean protocol stack with respect to user equipment and network apparatus in mobile communications. It is believed that the various proposed schemes in accordance with the present disclosure may address or otherwise alleviate the aforementioned issue(s).

In one aspect, a method may involve a processor of an apparatus communicating with a network node of a wireless network by utilizing a lean protocol stack. In utilizing the lean protocol stack, the method may involve the processor performing one or more of the following: (i) a split-stack operation; (ii) data concatenation; and (iii) UL scheduling optimization.

In another aspect, an apparatus may include a transceiver configured to communicate wirelessly. The apparatus may also include a processor communicatively coupled to the transceiver. The processor may communicate, via the transceiver, with a network node of a wireless network by utilizing a lean protocol stack. In utilizing the lean protocol stack, the processor may perform one or more of the following: (i) a split-stack operation; (ii) data concatenation; and (iii) UL scheduling optimization.

It is noteworthy that, although description provided herein may be in the context of certain radio access technologies, networks and network topologies such as 5th Generation (5G) or NR, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example network environment in which various proposed schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a block diagram of an example communication system in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to utilizing a lean protocol stack with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

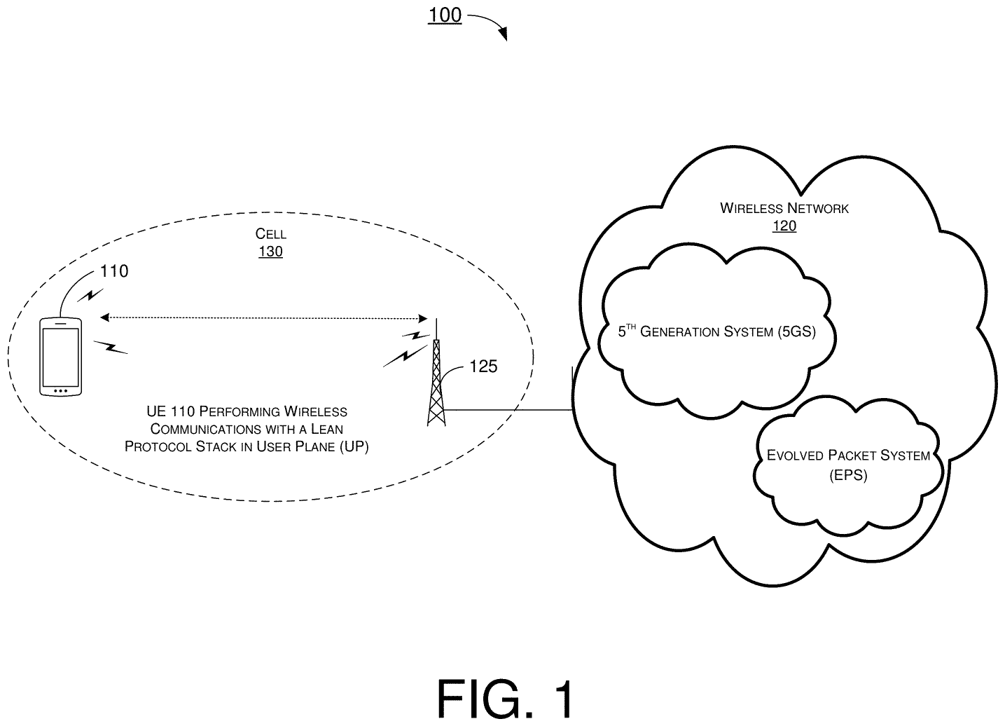

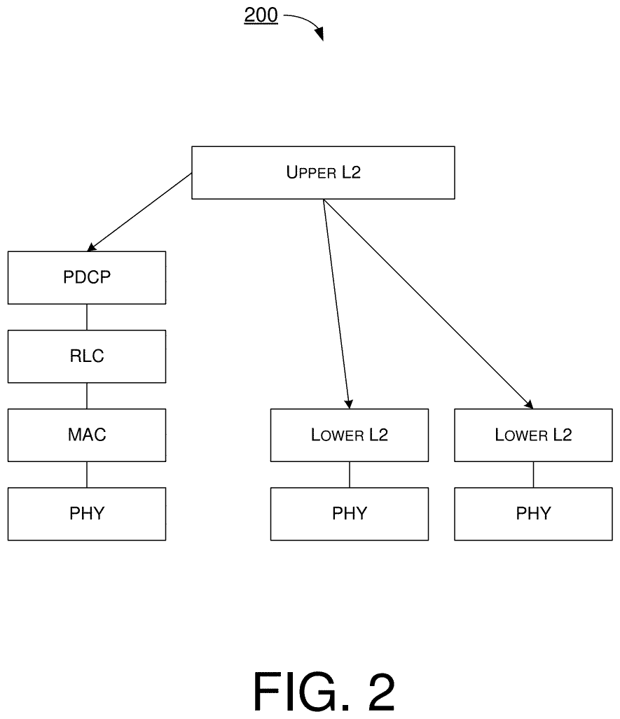

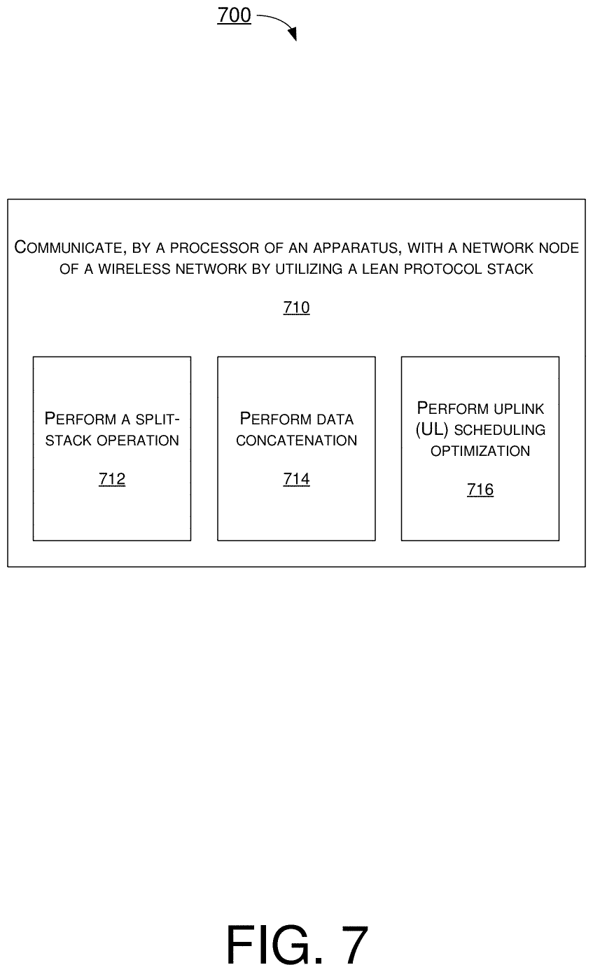

FIG. 1 illustrates an example network environment 100 in which various solutions and schemes in accordance with the present disclosure may be implemented. FIG. 2˜FIG. 7 illustrate examples of implementation of various proposed schemes in network environment 100 in accordance with the present disclosure. The following description of various proposed schemes is provided with reference to FIG. 1˜FIG. 7.

Referring to FIG. 1, network environment 100 may involve a UE 110 and a wireless network 120, which may include a 5^{th} Generation System (5GS) (and, optionally, an EPS). Depending on channel condition, availability and/or other factor(s), UE 110 may be in wireless communication with wireless network 120 via one or more network nodes (e.g., base station(s) such as eNB, gNB and/or transmission/reception point (TRP)) and/or one or more non-terrestrial network nodes (e.g., satellite(s)). For simplicity in illustration and without limiting the scope of the present disclosure, UE 110 may be associated with or otherwise in communication with a cell 130 corresponding to a network node 125 (e.g., gNB, eNB or TRP) of wireless network 120. In network environment 100, UE 110 and wireless network 120 may implement various schemes pertaining to utilization of a lean protocol stack with respect to user equipment and network apparatus in mobile communications in accordance with the present disclosure, as described below. It is noteworthy that, while the various proposed schemes may be individually or separately described below, in actual implementations each of the proposed schemes may be utilized individually or separately. Alternatively, some or all of the proposed schemes may be utilized jointly.

Under a proposed scheme in accordance with the present disclosure regarding a lean protocol stack, conceptually the protocol stack may be split into two, namely a low-throughput stack (herein interchangeably referred to as a “thin pipe”) and a high-throughput stack (herein interchangeably referred to as a “fat pipe”). Under the proposed scheme, the thin pipe may be utilized for the transfer of control plane (CP) information, low-throughput data and/or control information (e.g., MAC CEs). The fat pipe may be utilized for high-throughput information transfer. Under the proposed schemes, more than one fat pipes may be utilized and, in such cases, high-throughput data may be distributed in parallel through multiple fat pipes. The thin pipe may include some or all of NR functionality (e.g., PDCP, RLC, MAC and physical (PHY) layer functionality) and may serve or otherwise be utilized for a relatively lower throughput up to a lower maximum value. The fat pipe may contain reduced functionality compared to NR functionality (e.g., upper layer 2 (L2), lower L2 and PHY) and may serve or otherwise be utilized for a relatively high throughput up to a higher maximum value greater than that of the thin pipe. Moreover, the fat pipe may be utilized for optimized operations leveraging knowledge that this stack is only used for high-throughput operation(s).

FIG. 2 illustrates an example scenario 200 of a split-stack operation under the proposed scheme. Referring to FIG. 2, in a split-stack operation, data and information may be processed through a thin pipe or a fat pipe. The thin pipe, or low-throughput stack, may include at least the functionality of PDCP, RLC, MAC and PHY, and the thin pipe may be utilized to process low-throughput data and/or control information such as, for example and without limitation, CP signaling, low-throughput data and/or MAC CEs. The fat pipe, or high-throughput stack, may include the functionality of upper L2, lower L2 and PHY, and the fat pipe may be utilized to process high-throughput data and information. In the example shown in FIG. 2, there may be multiple fat pipes such that high-throughput data may be distributed over and processed in parallel through the multiple fat pipes.

Under another proposed scheme in accordance with the present disclosure regarding a lean protocol stack, data concatenation may be utilized to achieve a lean protocol stack. Under the proposed scheme, L2 data may be concatenated to form data chunks. Moreover, fixed-size chunk(s) may move L2 processing away from a per-packet basis to a per-chunk basis. The chunk size may be standardized or, alternatively, may be configurable (e.g., within a known set of values). Additionally, buffer status report (BSR) information and/or grant size may be multiples of a known chunk size (as opposed to bytes). Also, headers such as those at PDCP, RLC and/or MAC layer may be associated with a data chunk rather than a packet. Furthermore, LCP may be performed within each data chunk created. Alternatively, LCP may be performed across data chunks carried in a TB.

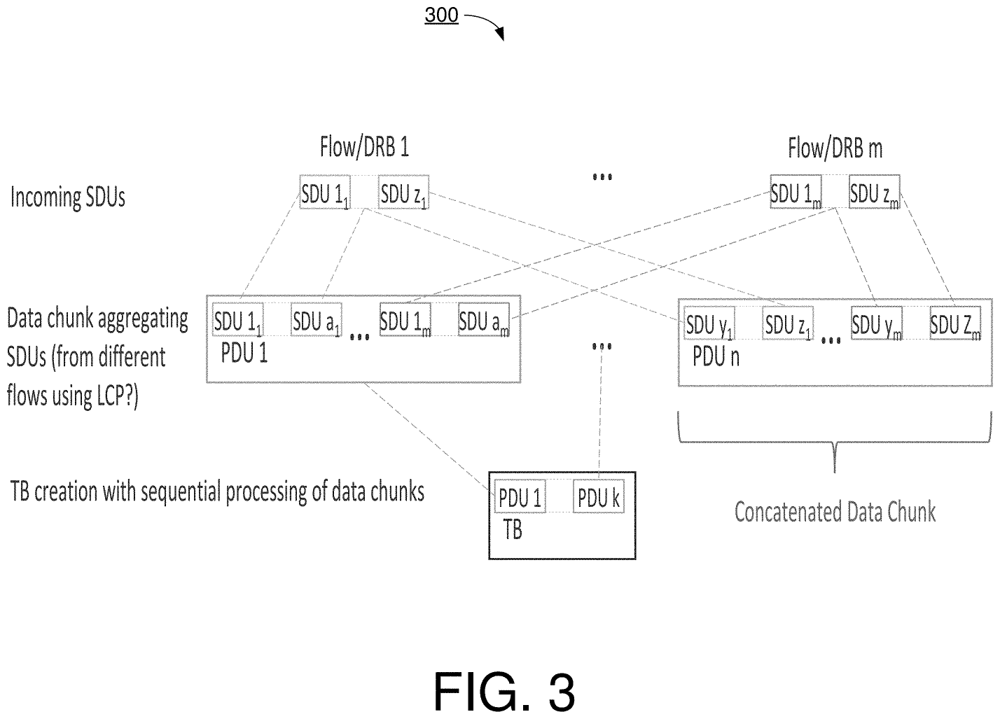

FIG. 3 illustrates an example scenario 300 of data concatenation under the proposed scheme. In the example shown in FIG. 3, incoming data in the form of incoming Service Data Units (SDUs) in each flow or data radio bearer (DRB) may be concatenated at L2 into data chunks (e.g., in the form of Protocol Data Units (PDUs)). For instance, each PDU of the plurality of PDUs may contain data chunks from different SDUs and/or different flows and/or different DRBs.

Under the proposed scheme, mapping of chunk size to a codeblock (CB) and/or CB group (CBG) size may enable storing of only those data chunks that fail decoding while enabling higher throughput without a proportional increase in memory requirement. Besides, individual CBG failure would not stall processing of other data in the TB. Under the proposed scheme, security may be moved down to chunk and/or CBG level to allow full L2 processing of successfully received chunks (e.g., to enable physical layer (PHY) level security). Additionally, cyclic redundancy check (CRC) may be replaced with integrity protection, such as Message Authentication Code-Integrity (MAC-I) for example, to check at the chunk and/or CBG level. Furthermore, data concatenation may be applied to the fat pipe given that it is known that the fat pipe is utilized for high-throughput operation(s).

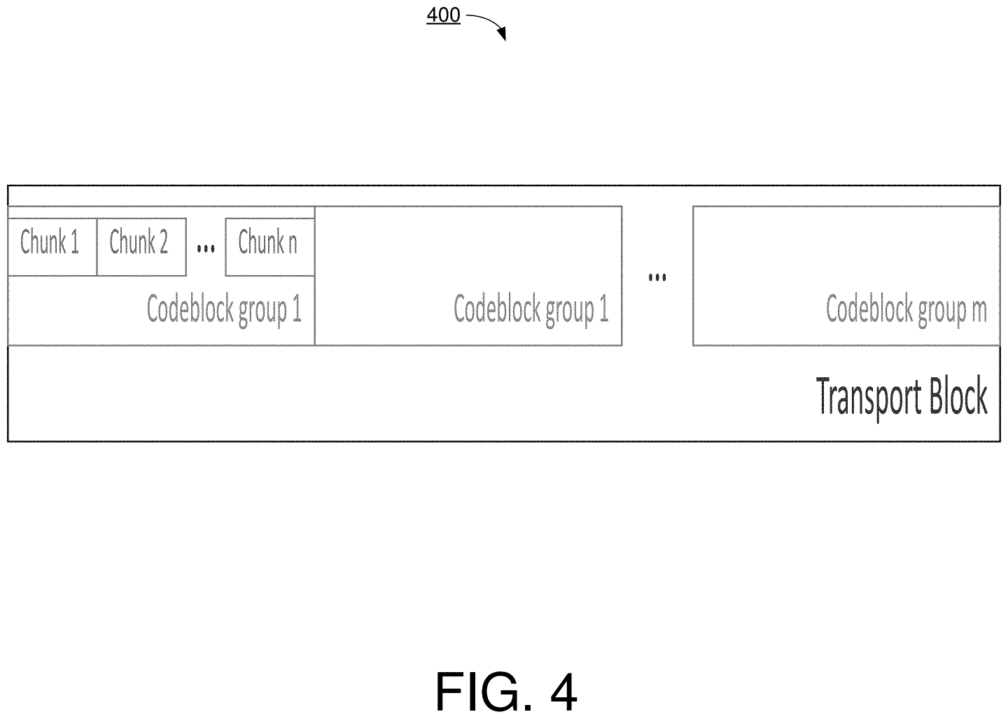

FIG. 4 illustrates an example scenario 400 of data concatenation under the proposed scheme. In the example shown in FIG. 4, each CBG of a plurality of CBGs may contain multiple data chunks (e.g., CBG 1 containing data chunks 1˜n, and so on), and the plurality of CBGs may be contained within a TB.

Under yet another proposed scheme in accordance with the present disclosure regarding a lean protocol stack, uplink scheduling optimization may be utilized to achieve a lean protocol stack. Under the proposed scheme, two levels of UL downlink control information (DCI) may be implemented, thereby decoupling grant size adaptation deadline from scheduling deadline. Moreover, a slower deadline may be applied to the determination of a UL TB size, and a slower deadline may also be used to reconfigure data chunk size. On the other hand, a faster deadline may be applied to actual scheduling of UL transmissions. It is believed that UL scheduling optimization may help in hard real-time (HRT) deadline reduction for UL traffic due to a-priori knowledge.

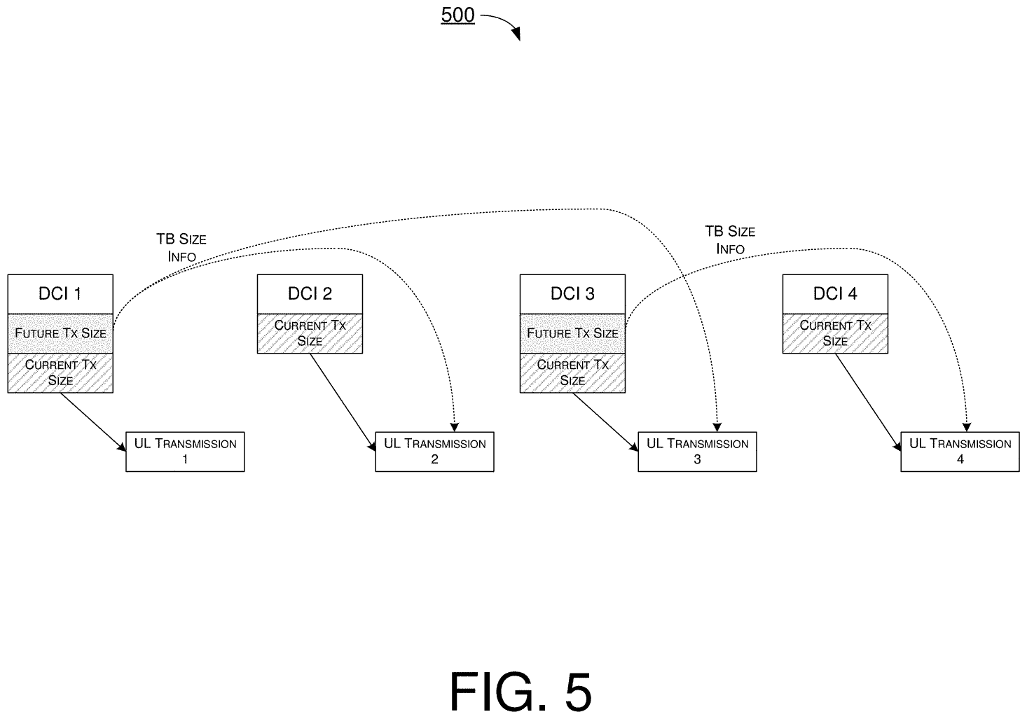

FIG. 5 illustrates an example scenario 500 of UL scheduling optimization under the proposed scheme. In the example shown in FIG. 5, there may be multiple DCIs (e.g., DCI 1, DCI 2, DCI 3 and DCI 4) belonging to the two levels of DCI (e.g., DCI 1 and DCI 3 being of one level while DCI 2 and DCI 4 being of the other level). Referring to FIG. 5, each of DCI 1 and DCI 3 may indicate both of a future transmission size and a current transmission time. On the other hand, each of DCI 2 and DCI 4 may indicate a current transmission time. For instance, DCI 1 may indicate the current transmission time for an UL transmission 1, and DCI 1 may also indicate the TB size information for a future transmission (e.g., UL transmission 2). Additionally, DCI 2 may indicate the current transmission time of UL transmission 2. Moreover, DCI 3 may indicate the current transmission time for an UL transmission 3, and DCI 3 may also indicate the TB size information for a future transmission (e.g., UL transmission 4). Furthermore, DCI 4 may indicate the current transmission time of UL transmission 4.

### Illustrative Implementations

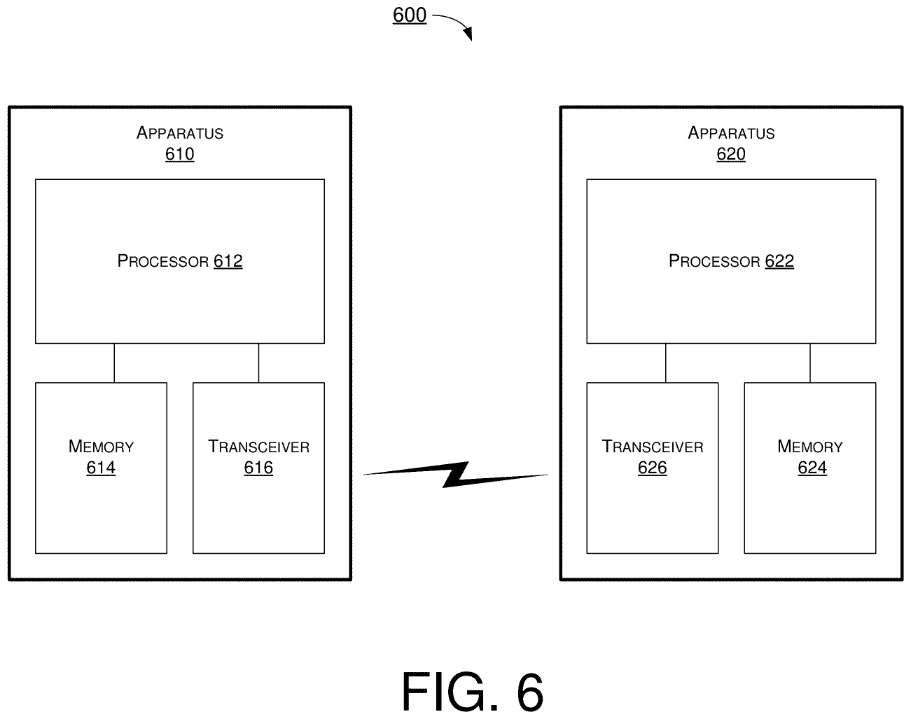

FIG. 6 illustrates an example communication system 600 having at least an example apparatus 610 and an example apparatus 620 in accordance with an implementation of the present disclosure. Each of apparatus 610 and apparatus 620 may perform various functions to implement schemes, techniques, processes and methods described herein pertaining to utilization of a lean protocol stack with respect to user equipment and network apparatus in mobile communications, including the various schemes described above with respect to various proposed designs, concepts, schemes, systems and methods described above, including network environment 100, as well as processes described below.

Each of apparatus 610 and apparatus 620 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 610 and apparatus 620 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 610 and apparatus 620 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in an eNodeB in an LTE, LTE-Advanced or LTE-Advanced Pro network or in a gNB or TRP in a 5G network, an NR network or an IoT network.

In some implementations, each of apparatus 610 and apparatus 620 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 610 and apparatus 620 may be implemented in or as a network apparatus or a UE. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC or RISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to utilization of a lean protocol stack with respect to user equipment and network apparatus in mobile communications in accordance with various implementations of the present disclosure.

In some implementations, apparatus 610 may also include a transceiver 616 coupled to processor 612. Transceiver 616 may be capable of wirelessly transmitting and receiving data. In some implementations, transceiver 616 may be capable of wirelessly communicating with different types of wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs/wireless networks of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 614 and memory 624 may include a UICC.

Each of apparatus 610 and apparatus 620 may be a communication entity capable of communicating with each other using various proposed schemes in accordance with the present disclosure. For illustrative purposes and without limitation, a description of capabilities of apparatus 610, as a UE (e.g., UE 110), and apparatus 620, as a network node (e.g., network node 125) of a wireless network (e.g., wireless network 120), is provided below.

Under certain proposed schemes in accordance with the present disclosure with respect to utilization of a lean protocol stack with respect to user equipment and network apparatus in mobile communications, processor 612 of apparatus 610, implemented in or as UE 110, may communicate, via transceiver 616, with apparatus 620 (as network node 125 of wireless network 120) by utilizing a lean protocol stack. In utilizing the lean protocol stack, processor 612 may perform one or more of the following: (i) a split-stack operation; (ii) data concatenation; and (iii) UL scheduling optimization.

In some implementations, in performing the split-stack operation, processor 612 may perform certain operations. For instance, processor 612 may process a first flow through a thin pipe. Moreover, processor 612 may process one or more second flows of high-throughput data through one or more fat pipes.

In some implementations, the first flow may include a flow of low-throughput data, control information, or both. Additionally, each of the one or more second flows may include a flow of high-throughput data, information, or both.

In some implementations, the thin pipe may include some or all NR functionality. Moreover, each of the one or more fat pipes may include reduced functionality compared to the thin pipe.

In some implementations, in performing the split-stack operation, processor 612 may also apply data concatenation in the fat pipe.

In some implementations, in performing the data concatenation, processor 612 may concatenate L2 data to form a plurality of data chunks of a fixed chunk size such that L2 processing of data is at a per-chunk basis.

In some implementations, each of a BSR and a grant size may be a multiple of the chunk size.

In some implementations, each header at a PDCP layer, a RLC layer and a MAC layer may be associated with a respective data chunk of the plurality of data chunks.

In some implementations, in performing the data concatenation, processor 612 may also perform LCP within each of the one or more data chunks of the plurality of data chunks. Alternatively, in performing the data concatenation, processor 612 may also perform LCP across multiple data chunks of the plurality of data chunks carried in a TB.

In some implementations, the chunk size may be mapped to a CB size or a CBG size.

In some implementations, in performing the data concatenation, processor 612 may also perform integrity protection at a chunk level, a CB level or a CBG level.

In some implementations, in performing the UL scheduling optimization, processor 612 may utilize two levels of UL DCI such that a grant size adaptation deadline is decoupled from a scheduling deadline.

In some implementations, in performing the UL scheduling optimization, processor 612 may also apply a slower deadline in determining an UL TB size. Additionally, processor 612 may apply a faster deadline in scheduling an UL transmission.

In some implementations, the slower deadline may also be utilized in reconfiguring a data chunk size.

### Illustrative Processes

FIG. 7 illustrates an example process 700 in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to utilization of a lean protocol stack with respect to user equipment and network apparatus in mobile communications. Process 700 may include one or more operations, actions, or functions as illustrated by one or more of block 710 as well as subblocks 712, 714 and 716. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 610 and apparatus 620 as well as any variations thereof. Solely for illustrative purposes and without limiting the scope, process 700 is described below in the context of apparatus 610 as a UE (e.g., UE 110) and apparatus 620 as a communication entity such as a network node or base station (e.g., network node 125) of a network (e.g., wireless network 120). Process 700 may begin at block 710.

At 710, process 700 may involve processor 612 of apparatus 610 communicating, via transceiver 616, with apparatus 620 (as network node 125 of wireless network 120) by utilizing a lean protocol stack. In utilizing the lean protocol stack, process 700 may involve processor 612 performing one or more operations represented by 712, 714 and 716.

At 712, process 700 may involve processor 612 performing a split-stack operation.

At 714, process 700 may involve processor 612 performing data concatenation.

At 716, process 700 may involve processor 612 performing UL scheduling optimization.

In some implementations, in performing the split-stack operation, process 700 may involve processor 612 performing certain operations. For instance, process 700 may involve processor 612 processing a first flow through a thin pipe. Moreover, process 700 may involve processor 612 processing one or more second flows of high-throughput data through one or more fat pipes.

In some implementations, the first flow may include a flow of low-throughput data, control information, or both. Additionally, each of the one or more second flows may include a flow of high-throughput data, information, or both.

In some implementations, the thin pipe may include some or all NR functionality. Moreover, each of the one or more fat pipes may include reduced functionality compared to the thin pipe.

In some implementations, in performing the split-stack operation, process 700 may also involve processor 612 applying data concatenation in the fat pipe.

In some implementations, in performing the data concatenation, process 700 may involve processor 612 concatenating L2 data to form a plurality of data chunks of a fixed chunk size such that L2 processing of data is at a per-chunk basis.

In some implementations, each of a BSR and a grant size may be a multiple of the chunk size.

In some implementations, each header at a PDCP layer, a RLC layer and a MAC layer may be associated with a respective data chunk of the plurality of data chunks.

In some implementations, in performing the data concatenation, process 700 may also involve processor 612 performing LCP within each of the one or more data chunks of the plurality of data chunks. Alternatively, in performing the data concatenation, process 700 may also involve processor 612 performing LCP across multiple data chunks of the plurality of data chunks carried in a TB.

In some implementations, the chunk size may be mapped to a CB size or a CBG size.

In some implementations, in performing the data concatenation, process 700 may also involve processor 612 performing integrity protection at a chunk level, a CB level or a CBG level.

In some implementations, in performing the UL scheduling optimization, process 700 may involve processor 612 utilizing two levels of UL DCI such that a grant size adaptation deadline is decoupled from a scheduling deadline.

In some implementations, in performing the UL scheduling optimization, process 700 may also involve processor 612 applying a slower deadline in determining an UL TB size. Additionally, process 700 may further involve processor 612 applying a faster deadline in scheduling an UL transmission.

In some implementations, the slower deadline may also be utilized in reconfiguring a data chunk size.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
communicating, by a processor of an apparatus, with a network node of a wireless network by utilizing a lean protocol stack,
wherein the utilizing of the lean protocol stack comprises one or more of:
performing a split-stack operation;
performing data concatenation; and
performing uplink (UL) scheduling optimization.

2. The method of claim 1, wherein the performing of the split-stack operation comprises:
processing a first flow through a thin pipe; and
processing one or more second flows of high-throughput data through one or more fat pipes.

3. The method of claim 2, wherein the first flow comprises a flow of low-throughput data, control information, or both, and wherein each of the one or more second flows comprises a flow of high-throughput data, information, or both.

4. The method of claim 2, wherein the thin pipe includes some or all of New Radio (NR) functionality, and wherein each of the one or more fat pipes includes reduced functionality compared to the thin pipe.

5. The method of claim 2, wherein the performing of the split-stack operation further comprises applying data concatenation in the fat pipe.

6. The method of claim 1, wherein the performing of the data concatenation comprises concatenating layer 2 (L2) data to form a plurality of data chunks of a fixed chunk size such that L2 processing of data is at a per-chunk basis.

7. The method of claim 6, wherein each of a buffer status report (BSR) and a grant size is a multiple of the chunk size.

8. The method of claim 6, wherein each header at a Packet Data Convergence Protocol (PDCP) layer, a Radio Link Control (RLC) layer and a Medium Access Control (MAC) layer is associated with a respective data chunk of the plurality of data chunks.

9. The method of claim 6, wherein the performing of the data concatenation further comprises performing logical channel prioritization (LCP) within each of the one or more data chunks of the plurality of data chunks.

10. The method of claim 6, wherein the performing of the data concatenation further comprises performing logical channel prioritization (LCP) across multiple data chunks of the plurality of data chunks carried in a transport block (TB).

11. The method of claim 6, wherein the chunk size is mapped to a codeblock (CB) size or a CB group (CBG) size.

12. The method of claim 11, wherein the performing of the data concatenation further comprises performing integrity protection at a chunk level, a CB level or a CBG level.

13. The method of claim 1, wherein the performing of the UL scheduling optimization comprises utilizing two levels of UL downlink control information (DCI) such that a grant size adaptation deadline is decoupled from a scheduling deadline.

14. The method of claim 13, wherein the performing of the UL scheduling optimization further comprises applying a slower deadline in determining an UL transport block (TB) size.

15. The method of claim 14, wherein the performing of the UL scheduling optimization further comprises applying a faster deadline in scheduling an UL transmission.

16. The method of claim 14, wherein the slower deadline is also utilized in reconfiguring a data chunk size.

17. An apparatus, comprising:
a transceiver configured to communicate wirelessly; and
a processor communicatively coupled to the transceiver, the processor configured to communicate, via the transceiver, with a network node of a wireless network by utilizing a lean protocol stack,
wherein the utilizing of the lean protocol stack comprises one or more of:
performing a split-stack operation;
performing data concatenation; and
performing uplink (UL) scheduling optimization.

18. The apparatus of claim 17, wherein the performing of the split-stack operation comprises:
processing a first flow through a thin pipe; and
processing one or more second flows of high-throughput data through one or more fat pipes.

19. The apparatus of claim 17, wherein the performing of the data concatenation comprises concatenating layer 2 (L2) data to form a plurality of data chunks of a fixed chunk size such that L2 processing of data is at a per-chunk basis.

20. The apparatus of claim 17, wherein the performing of the UL scheduling optimization comprises utilizing two levels of UL downlink control information (DCI) such that a grant size adaptation deadline is decoupled from a scheduling deadline.
